(19) United States
(12) Patent Application Publication
(10) Pub. No.: US 2013/0187626 A1
(43) Pub. Date: Jul. 25, 2013

(54) Soft Switch Driving Circuit

(71) Applicants: Chih-Heng Su, Hsinchu City (TW); Yang-Fan Su, Tainan City (TW)

(72) Inventors: Chih-Heng Su, Hsinchu City (TW); Yang-Fan Su, Tainan City (TW)

(21) Appl. No.: 13/442,889

(22) Filed: Apr. 10, 2012

(30) Foreign Application Priority Data
Jan. 19, 2012 (TW) 101102179

(51) Int. Cl. G05F 3/08

(52) U.S. Cl. 323/311

(57) ABSTRACT

A soft switch driving circuit is disclosed for a DC converter, to transform an input voltage into an output voltage. The soft switch driving circuit includes a regulating module for outputting a reference voltage, a first bootstrap circuit for generating a first voltage value according to a DC voltage, a second bootstrap circuit for generating a second voltage value according to the reference voltage, a control module for generating a plurality of control signals according to a control voltage, a switch module having one end coupled to the first bootstrap circuit and another end coupled to the second bootstrap circuit for outputting a voltage signal, and an output circuit connected to the control module and the switch module for transforming the input voltage into the output voltage according to the voltage signal and one of the plurality of controlling signals.

### BACKGROUND OF THE INVENTION

1. Field of the Invention

The present invention relates to a soft switch driving circuit, and more particularly, to a soft switch driving circuit which utilizes a plurality of bootstrap circuits and a switch module to generate a plurality of driving voltages, so as to transform an input voltage into an output voltage.

2. Description of the Prior Art

Generally, DC-DC voltage converters are classified into two groups, one is a buck (step down) converter and the other is a boost (step up) converter. The buck converter can decrease an input DC voltage to a default voltage level, and the boost converter can increase an input DC voltage. With development, both the buck and boost converters are varied and modified to conform to different system architectures and requirements.

Please refer to FIG. 1, which illustrates a conventional schematic diagram of a bootstrap circuit 106 being utilized in a boost/buck converter 10. The bootstrap circuit 106 includes a bootstrap capacitor C_BS and a diode D_BS. Additionally, the boost/buck converter 10 further includes a driving circuit 100, an output circuit 102 and a control module 104. The driving circuit 100 includes transistors Q1, Q2 and driving units DRV_1, DRV_2. The control module 104 generates control signals VCTRL, V_CTRL_B to input to the driving units DRV_1, DRV_2, and to control conducting conditions of the transistors Q1, Q2 in order to output a switch signal to a terminal point Y. The outputting circuit 102 coupled to the terminal point Y includes an inductor L, a capacitor C and feedback resistors R1, R2. The output circuit 102 utilizes the switch signal and the inductor L to operate a power switch at an output port. The feedback resistors R1, R2 generate a feedback voltage VFB for the control module 104 to generate the control signals V_CTRL, V_CTRL_B. Therefore, the bootstrap circuit 106 operates a charge/discharge process at terminal points X, Y of the bootstrap capacitor C_BS according to the conducting conditions of the transistors Q1, Q2, and outputs a conducting current passing through the inductor L. Furthermore, the control module 104 determines a switch frequency of the above two conducting conditions to provide a proper voltage/switch-frequency.

Please refer to FIG. 2, which illustrates a schematic diagram of a bootstrap circuit module 200 driving a gate driving circuit 20. The bootstrap circuit module 200 is a simplified block diagram of the bootstrap circuit 106 and other control circuits thereof in FIG. 1. As shown in FIG. 2, the gate driving circuit 20 includes an up-bridge switch M1, a down-bridge switch M2, a parasitic inductor CL, an inductor L, a capacitor C and a controller 202. The bootstrap circuit module 200 is coupled to the up-bridge switch M1 to supply different driving voltages to the up-bridge switch M1. The parasitic inductor CL is coupled between the up-bridge switch M1 and the down-bridge switch M2. The down-bridge switch M2 includes a parasitic diode D_body. When the down-bridge switch M2 and the up-bridge switch M1 are both turned off, the parasitic diode D_body provides a forward-bias current to provide the inductor L a continuous current. When the bootstrap circuit module 200 drives the up-bridge switch M1, the up-bridge switch M1 provides a larger in-rush current passing through the inductor L to turn off the parasitic diode D_body. During the process of turning off the parasitic diode D_body, a driving current passing through the up-bridge switch M1 causes a large amount of reverse-bias current passing through the parasitic diode D_body via the parasitic inductor CL to suddenly turn off the parasitic diode D_body. While the parasitic diode D_body is turned off, the large amount of reverse-bias current passing through the parasitic inductor CL disappears. Accordingly, a terminal point PK generates a voltage pulse higher than a voltage of a terminal point Z, which results in a higher in-rush voltage to damage the drain (i.e. the terminal point PK) of the down-bridge switch M2 due to insufficient voltage blocking capability. During the practical chip design process, the up-bridge switch M1 is close to the only output pin of the chip to avoid a parasitic inductor (not shown in the figure) of the up-bridge switch M1 having the same voltage pulse. In this situation, a longer wire of the down-bridge switch M2 is inevitable, which exaggerates the in-rush current passing through the parasitic inductor CL and elevates a damage probability of the down-bridge switch M2. Therefore, it has become an important issue to provide another soft switch driving circuit, which adaptively controls an initial voltage state of the up-bridge switch M1 to confine the sudden reverse-bias current passing through the parasitic diode D_body of the down-bridge switch M2 without dramatically changing the original design for the up-bridge switch M1 and the down-bridge switch M2.

### SUMMARY OF THE INVENTION

It is therefore an objective of the invention to provide a soft switch driving circuit.

The present invention discloses a soft switch driving circuit for a DC converter to transform an input voltage into an output voltage including a regulating module for outputting a reference voltage; a first bootstrap circuit for generating a first voltage value according to a DC voltage; a second bootstrap circuit for generating a second voltage value according to the reference voltage; a control module for generating a plurality of control signals according to a control voltage; a switch module having one end coupled to the first bootstrap circuit and another end coupled to the second bootstrap circuit for outputting a voltage signal according to the DC voltage, the first voltage value, the second voltage value and the plurality of control signals; and an output circuit electrically connected to the control module and the switch module for transforming the input voltage into the output voltage according to the voltage signal and one of the plurality of controlling signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional schematic diagram of a bootstrap circuit being utilized in a boost/buck converter.

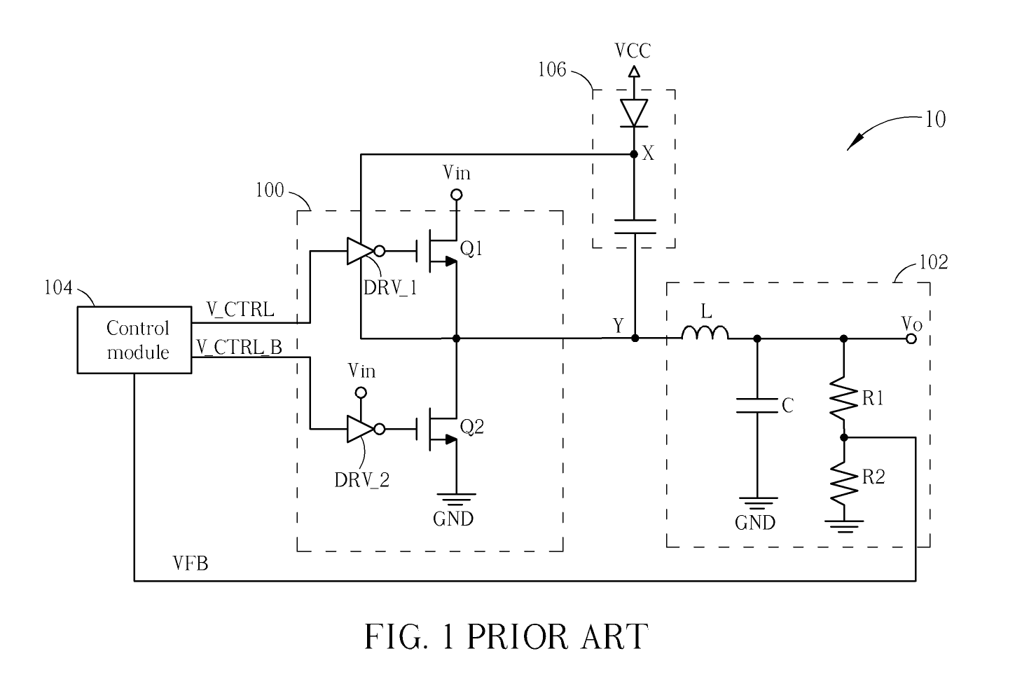

FIG. 2 illustrates a schematic diagram of a bootstrap circuit module driving a gate driving circuit.

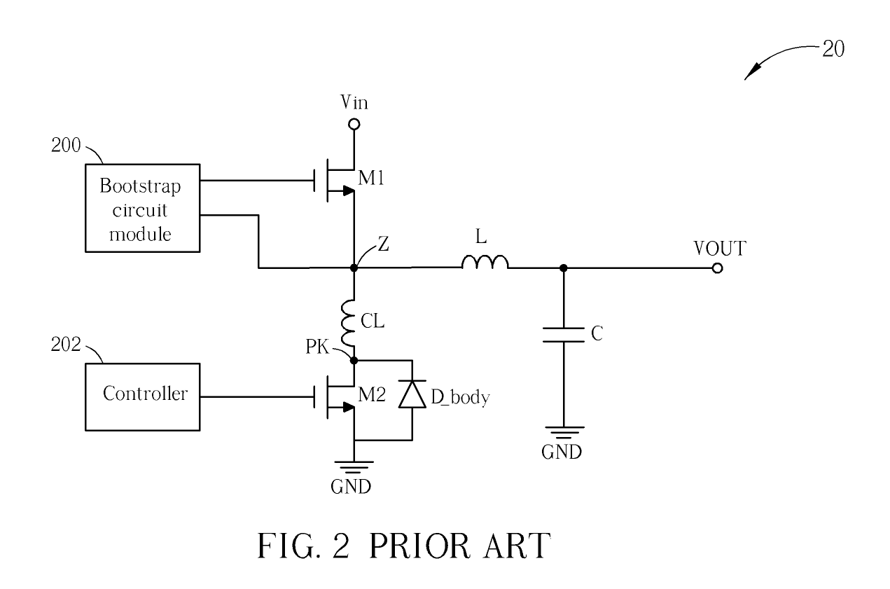

FIG. 3 illustrates a schematic diagram of a soft switch driving circuit according to an embodiment of the invention.

FIG. 4 illustrates a comparative diagram of the voltage between the invention and the prior art at different terminal points.

FIG. 5 illustrates a flow chart of the soft switch driving process according to an embodiment of the invention.

### DETAILED DESCRIPTION

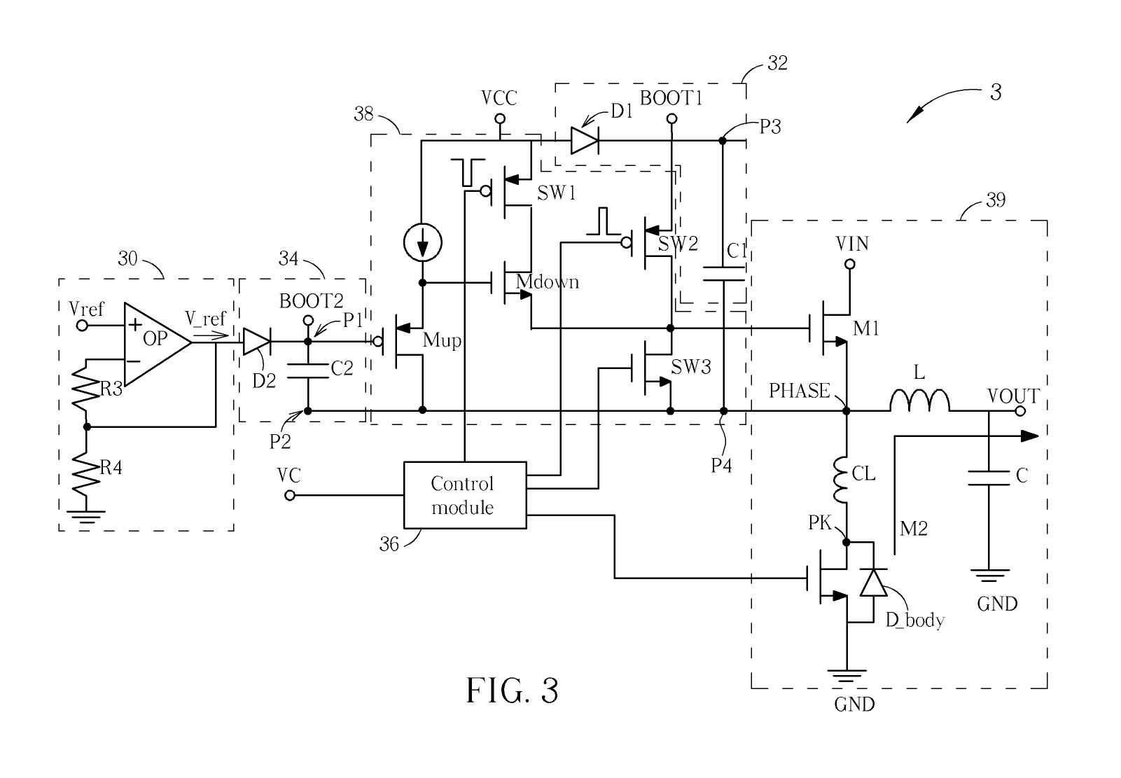

Please refer to FIG. 3, which illustrates a schematic diagram of a soft switch driving circuit 3 according to an embodiment of the invention. As shown in FIG. 3, the soft switch driving circuit 3 includes a regulating module 30, a first bootstrap circuit 32, a second bootstrap circuit 34, a control module 36, a switch module 38 and an output circuit 39. The regulating module 30 includes an operational amplifier OP and division-voltage resistors R3, R4, and utilizes a voltage source Vref to output a reference voltage V_ref. The first bootstrap circuit 32 includes a diode D1 and a capacitor C1, and the second bootstrap circuit 34 also includes a diode D2 and a capacitor C2. Similar to the bootstrap circuit 106 of the prior art, the first bootstrap circuit 32 utilizes the diode D1 and the capacitor C1 to generate a first voltage value BOOT1 according to a DC voltage VCC, and the second bootstrap circuit 34 utilizes the diode D2 and the capacitor C2 to generate a second voltage value BOOT2 according to the reference voltage V_ref. The switch module 38 includes a first switch unit SW1, a second switch unit SW2, a third switch unit SW3, an elevating unit Mup and a lowering unit Mdown, and the mentioned units are realized by MOS transistors in this embodiment. The control module 36 generates a plurality of control signals according to a control voltage VC. For the users' requirements, the plurality of control signals are inputted to the first switch unit SW1, the second switch unit SW2 and the third switch unit SW3 to control conducting conditions thereof. The switch module 38 utilizes the elevating unit Mup to couple to the second bootstrap circuit 34, and the first switch unit SW1, the second switch unit SW2 and the third switch unit SW3 to couple to the first bootstrap circuit 32 and the control module 36. The output circuit 39 is similar to the gate driving circuit 20 of the prior art, and includes a bridge switch (i.e. the up-bridge switch M1 and the down-bridge switch M2), the parasitic inductor CL, the inductor L and the capacitor C. The output circuit 39 is coupled to the control module 36, i.e. receiving the control signal via the down-bridge switch M2, and the switch module 38, so as to transform the input voltage VIN into the output voltage VOUT.

Preferably, the soft switch driving circuit 3 of the invention generates a two-stage driving voltage to input to the output circuit 39 via the control module 36 and the switch module 38, and to avoid a sudden larger voltage directly supplied to the down-bridge switch M2 inside the output circuit 39, which results in damage to the down-bridge switch M2. In this embodiment, the DC voltage source Vref, such as 1 Volt, is initially inputted to the regulating module 30 to generate the reference voltage V_ref, such as 6 Volts, and then the reference voltage V_ref is inputted to the second bootstrap circuit 34. Simultaneously, the control module 36 outputs the plurality of control signals to the switch module 38. At a first predetermined timing, such as from 0 to 10 nanoseconds, the plurality of control signals turn on the first switch unit SW1 and turn off the second switch unit SW2. In this situation, the second voltage value BOOT2 generated by the second bootstrap circuit 34 charges a terminal point P1 of the capacitor C2 from 6 Volts to 18 Volts. Accordingly, another terminal point P1 of the capacitor C2 has a voltage change from 0 to 12 Volts. Next, the second voltage value BOOT2 can sequentially boost/buck the same voltage value, such as 1 Volt, via the elevating unit Mup and the lowering unit Mdown, and inputted to the gate of the up-bridge switch M1 as the driving voltage. Therefore, during the process of turning on the first switch unit SW1 and turning off the second switch unit SW2, the driving voltage from 6 Volts to 18 Volts is transmitted to the gate of the first switch unit SW1, and correspondingly, the voltage from 0 to 12 Volts is transmitted to the source of the first switch unit SW1, where a voltage difference of 6 Volts between the gate and the source of the first switch unit SW1 can conduct the up-bridge switch M1. The terminal point PHASE of the parasitic inductor CL has an equivalent voltage to the terminal point P2 from 0 to 12 Volts. Afterward, at a second predetermined timing, such as from 10 nanoseconds to 20 nanoseconds, the control module 36 utilizes the plurality of control signals to turn off the first switch unit SW1 and turn on the second switch unit SW2. In this situation, the first voltage value BOOT1 generated by the first bootstrap circuit 32 is inputted to the gate and the source of the up-bridge switch M1 via the two terminal points P3, P4 of the capacitor C1, respectively. The first voltage value BOOT1 causes the terminal point P3 to have the voltage from 12 Volts to 24 Volts, and the terminal point P4 to have the voltage from 0 to 12 Volts, which maintains a voltage difference as 12 Volts between the gate and the source of the up-bridge switch M1 to make the up-bridge switch M1 conduct.

This embodiment focuses on the up-bridge switch M1 being turned on and the down-bridge switch M2 being turned off. For the current continuously passing through the inductor L, the parasitic diode D_body of the down-bridge switch M2 is utilized for generating the forward-bias current, and a reverse-bias current is needed if turning off the parasitic diode D_body. Besides, the reverse-bias current passing through the parasitic inductor CL can further determine a pulse voltage generated at the drain of the down-bridge switch M2. If the inductance of the parasitic inductor CL is fixed, the larger the reverse-bias current is, the larger the pulse voltage can be anticipated while turning off the parasitic diode D_body. However, a solution to the above problem can be provided by the soft switch driving circuit 3. The soft switch driving circuit 3 controls the first switch unit SW1 and the second switch unit SW2 serially to be on or off, and accordingly, the second voltage value BOOT2 and the first voltage value BOOT1 are supplied to the up-bridge switch M1 to form a two-stage driving voltage, i.e. two voltage differences are provided sequentially as 6 Volts and 12 Volts, so as to avoid directly driving the up-bridge switch M1 at a larger voltage. Consequently, the reverse-bias current can be reduced while the parasitic diode D_body is turned off, and the current passing through the parasitic inductor CL can be reduced as well, so as to lower the voltage pulse of the terminal point PK.

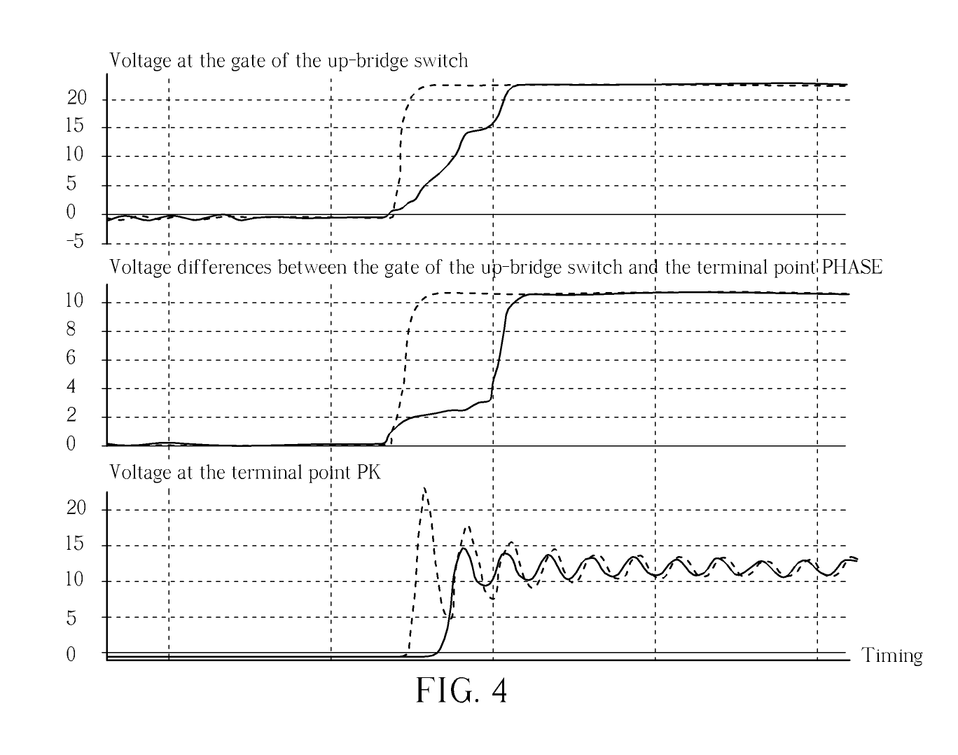

Please refer to FIG. 4, which illustrates a comparative diagram of the voltage between the invention and the prior art at different terminal points, where the visual line represents the voltage measured in the prior art excluding the soft switch driving circuit 3 and the solid line represents the voltage measured in the invention including the soft switch driving circuit 3, and they indicate the voltage of the gate of the up-bridge switch M1, the voltage difference between the gate of the up-bridge switch M1 and the terminal point PHASE, and the voltage of the terminal point PK from top to bottom. As shown in FIG. 4, by utilizing the soft switch driving circuit 3 of the invention, since the two-stage driving voltage is supplied to the up-bridge switch M1, a gradually increasing slope of the voltage curve is demonstrated to show the voltage difference between the gate of the up-bridge switch M1 and the terminal point PHASE. Also, the terminal point PK can prevent a larger voltage pulse that occurs in the prior art, as circled in FIG. 4, to enhance a protect mechanism of the down-bridge switch M2.

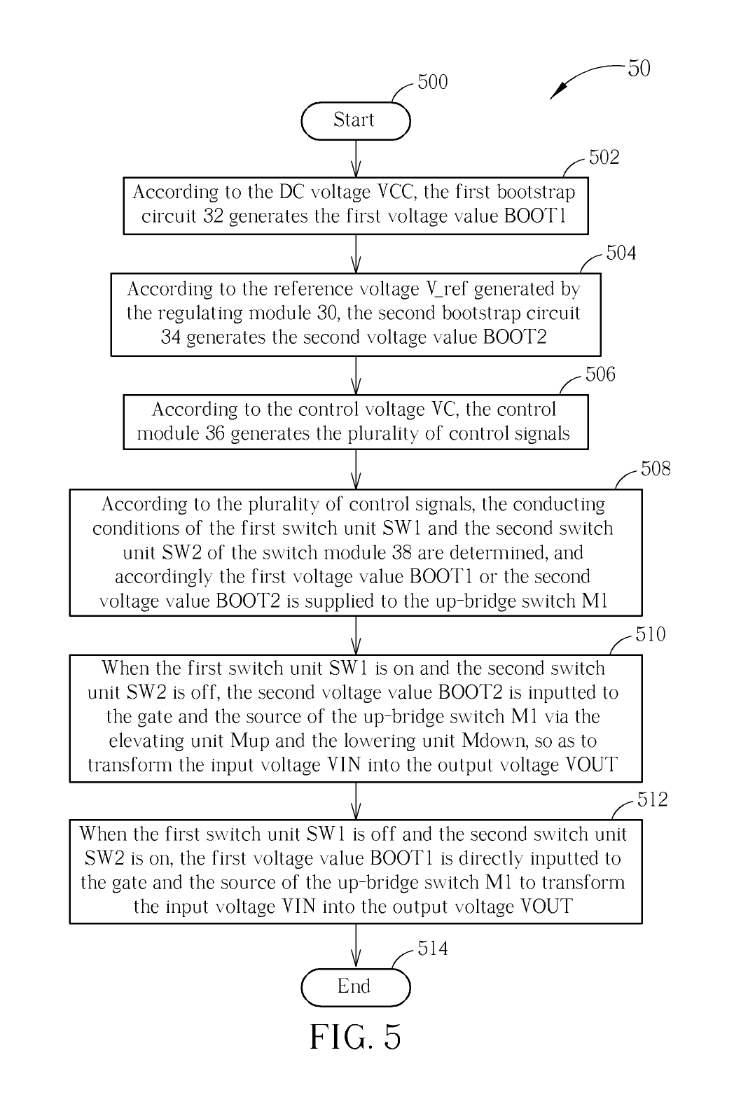

Noticeably, the embodiment of the invention provides an operational process utilizing the soft switch driving circuit 3, which can be summarized as a soft switch driving process 50, as shown in FIG. 5. The soft switch driving process 50 includes the steps as following:

Step 500: Start.

Step 502: According to the DC voltage VCC, the first bootstrap circuit 32 generates the first voltage value BOOT1.

Step 504: According to the reference voltage V_ref generated by the regulating module 30, the second bootstrap circuit 34 generates the second voltage value BOOT2.

Step 506: According to the control voltage VC, the control module 36 generates the plurality of control signals.

Step 508: According to the plurality of control signals, the conducting conditions of the first switch unit SW1 and the second switch unit SW2 of the switch module 38 are determined, and accordingly the first voltage value BOOT1 or the second voltage value BOOT2 is supplied to the up-bridge switch M1.

Step 510: When the first switch unit SW1 is on and the second switch unit SW2 is off, the second voltage value BOOT2 is inputted to the gate and the source of the up-bridge switch M1 via the elevating unit Mup and the lowering unit Mdown, so as to transform the input voltage VIN into the output voltage VOUT.

Step 512: When the first switch unit SW1 is off and the second switch unit SW2 is on, the first voltage value BOOT1 is directly inputted to the gate and the source of the up-bridge switch M1 to transform the input voltage VIN into the output voltage VOUT.

Step 514: End.

The soft switch driving process 50 can be understood in the related paragraphs of the soft switch driving circuit 3 and in FIG. 3, and is not described hereinafter for simplicity. Noticeably, in this embodiment, the soft switch driving process 50 utilizes the step 508 and the step 510 to generate the two-stage driving voltage, i.e. the gate and the source of the up-bridge switch M1 provide the voltage differences as 6 Volts and 12 Volts, to reduce the larger in-rush current passing through the parasitic inductor CL and avoid the higher pulse voltage at the terminal point PK. Therefore, those skilled in the art can change/modify the soft switch driving circuit 3 of the invention with other additional voltage bulk/boost mechanisms or current increase/reduction mechanisms to drive the up-bridge switch M1 with a multi-stage driving voltage. It is optional to combine the embodiment of the invention with other comparison circuits to adaptively adjust the driving voltages for the up-bridge switch M1, or to drive the up-bridge switch M1 and the down-bridge switch M2 respectively or simultaneously in order to avoid the in-rush current passing through the parasitic inductor CL and prevent the pulse voltage, which is also in the scope of the invention.

In summary, the invention provides a soft switch driving circuit utilizing a plurality of bootstrap circuits, a switch module and a control module to generate a plurality of multi-stage driving voltages for input to an up-bridge switch of an output circuit. Consequently, it provides a smaller in-rush current passing through a parasitic capacitor, and has a gradual slope of a voltage curve at a terminal point, such as the terminal point PK in the embodiment. A protection mechanism of a down-bridge switch of the output circuit is improved, and users have the advantage of dynamically adjusting the driving voltage of the output circuit for different requirements, which also expands product applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A soft switch driving circuit for a DC converter to transform an input voltage into an output voltage comprising:
a regulating module for outputting a reference voltage;
a first bootstrap circuit for generating a first voltage value according to a DC voltage;
a second bootstrap circuit for generating a second voltage value according to the reference voltage;
a control module for generating a plurality of control signals according to a control voltage;
a switch module having one end coupled to the first bootstrap circuit and another end coupled to the second bootstrap circuit for outputting a voltage signal according to the DC voltage, the first voltage value, the second voltage value and the plurality of control signals; and
an output circuit electrically connected to the control module and the switch module for transforming the input voltage into the output voltage according to the voltage signal and one of the plurality of controlling signals.

2. The soft switch driving circuit of claim 1, wherein the switch module further comprises a first switch unit and a second switch unit, and conducting conditions of the first switch unit and the second switch unit are determined according to the plurality of controlling signals.

3. The soft switch driving circuit of claim 2, wherein the switch module further comprises an elevating unit and a lowering unit to elevate or lower the second voltage value, so as to generate the voltage signal.

4. The soft switch driving circuit of claim 3, wherein the output circuit further comprises:
a bridge circuit comprising an up-bridge switch and a down-bridge switch for transforming the input voltage into the output voltage according to the conducting conditions of the first switch unit and the second switch unit.

5. The soft switch driving circuit of claim 4, wherein when the first switch unit turns on and the second switch unit turns off, the switch module outputs the second voltage value as the voltage signal.

6. The soft switch driving circuit of claim 5, wherein when the first switch unit does not conduct and the second switch unit conducts, the switch module outputs the first voltage value as the voltage signal.

7. The soft switch driving circuit of claim 6, wherein the up-bridge switch is operated in a plurality of bias ranges to correspondingly output a plurality of current values passing through a parasitic capacitor according to the voltage signal.

8. The soft switch driving circuit of claim 4, wherein the output circuit further comprises an inductor and a capacitor to transform the input voltage into the output voltage.

9. The soft switch driving circuit of claim 3, wherein the switch module further comprises a third switch unit, and a conducting condition of the third switch unit is determined according to the controlling signal.

10. The soft switch driving circuit of claim 9, wherein the switch module utilizes the first switch unit, the second switch unit and the third switch unit to couple to the first bootstrap circuit, and utilizes the third switch unit and the elevating unit to couple to the second bootstrap circuit.
